(19) United States
(12) Patent Application Publication
(10) Pub. No.: US 2006/0279947 A1
(43) Pub. Date: Dec. 14, 2006

(54) Portable insulated cooler with internal illumination

(76) Inventors: Donald W. Henley JR., Cassopolis, MI (US); Jennifer Henley, Cassopolis, MI (US)

Correspondence Address: Galasso & Associates, LP, P.O. Box 26503, Austin, TX, 78755-0503, US

(21) Appl. No.: 11/447,800

(22) Filed: Jun. 6, 2006

Related U.S. Application Data
(60) Provisional application No. 60/690,087, filed on Jun. 11, 2005.

(51) Int. Cl. F25D 23/00; F21V 33/00; B65D 81/38

(52) U.S. Cl. 362/154; 220/592.02; 220/592.2; 362/155

(57) ABSTRACT

A portable cooler for maintaining contents disposed therein at an internal temperature dissimilar to that of the temperature of its external surroundings configured in substantially rectangular shape. The cooler includes a storage compartment configure with an insulated lid, four insulated walls and an insulated bottom defining an interior volume of the storage compartment. Mounted onto the internally facing surface of the lid is a light unit for illuminating the interior volume of the storage compartment. The portable cooler further includes a switch electrically coupled to the light unit and four retaining rings superposed on the lid configured to releasably secure a conventional beverage can.

### PRIORITY UNDER 35 U.S.C. §119(e) & 37 C.F.R. §1.78

This nonprovisional application claims priority based upon the following prior U.S. provisional patent application entitled: 'Lil fridge, Application No. 60/690,087, filed Jun. 11, 2005, in the names of Donals W. Henley JR. and Jennifer Henley, which is hereby incorporated by reference for all purposes.

### FIELD OF THE INVENTION

The present invention relates to a portable thermally isolating storage unit, more specifically but not by way of limitation to a portable thermally isolated storage unit that utilizes an internal light source to facilitate the viewing and selecting of contents stored within the portable thermally isolated storage unit in low light and dark conditions.

### BACKGROUND

Millions of people engage in picnicking, camping trips, and other activities where transportation of a variety of food and beverages is desirable. Transportation of these foods and beverages is usually conducted via some type of portable cooler in order to maintain optimum freshness and taste. The food and beverages are usually maintained in a state of thermal isolation via a cooling mechanism such as ice, dry ice or other type of refrigeration.

Many participants engage in these excursions during periods of time of which no natural light occurs. Many portable coolers have been manufactured and made available to the general consumer market. However, no current devices have been shown to address viewing the interior of the portable cooler and contents disposed therein when no external light source is available.

Participants commonly camp overnight and store most of there equipment such as flashlights, first aid kits in a tent or vehicle. The participants attend activities during their excursions and usually transport portable coolers containing the food and beverages. Many of these activities occur during the nighttime, which precipitates a requirement for easy and timely access to items contained in the portable cooler. Accordingly, there is a need for a portable cooler that has disposed therein an internal light source that facilitates easier viewing of the contents stored within the portable cooler.

### SUMMARY OF THE INVENTION

It is the object of the present invention to provide a portable container designed to easily transport items such as but not limited to food and beverages that can internally maintain a temperature dissimilar to that of its surroundings.

It is a further object of the present invention to provide a portable container that can internally maintain a temperature dissimilar to that of its surroundings that has disposed substantially therein a light source to facilitate the viewing of the contents contained within the portable container.

Another object of the present invention is to provide a portable container that has a light source that is operably connected to a switch.

Yet another object of the present invention is to provide a portable container that can internally maintain a temperature dissimilar to that of its surroundings that is lightweight and inexpensive.

To the accomplishment of the above and related objects the present invention may be embodied in the form illustrated in the accompanying drawings. Attention is called to the fact that the drawings are illustrative only. Variations are contemplated as being part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention with the lid in an open position; and

FIG. 2 is a perspective view of an embodiment of the present invention with the lid in a closed position.

### DETAILED DESCRIPTION

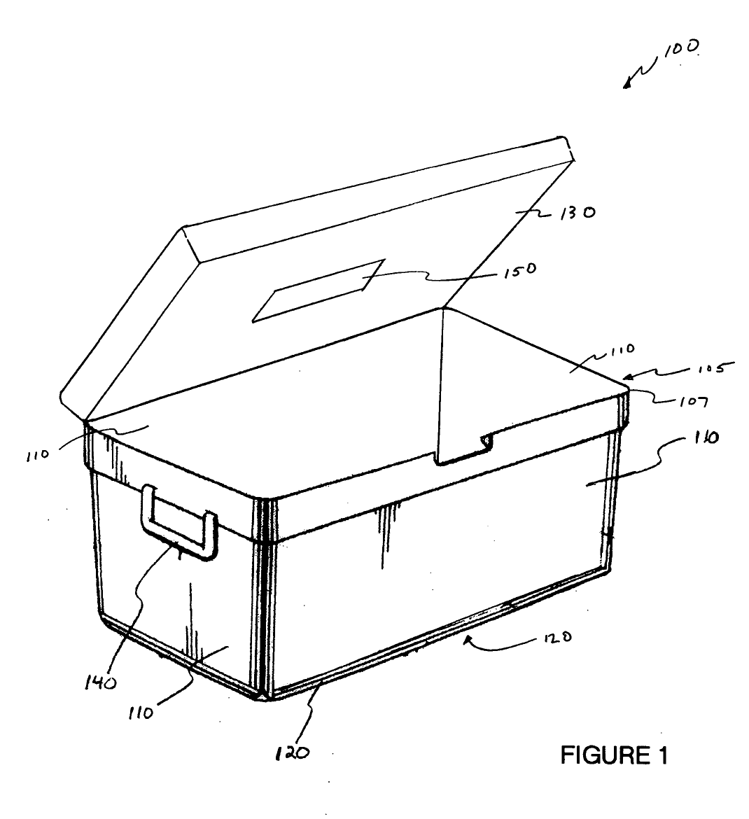

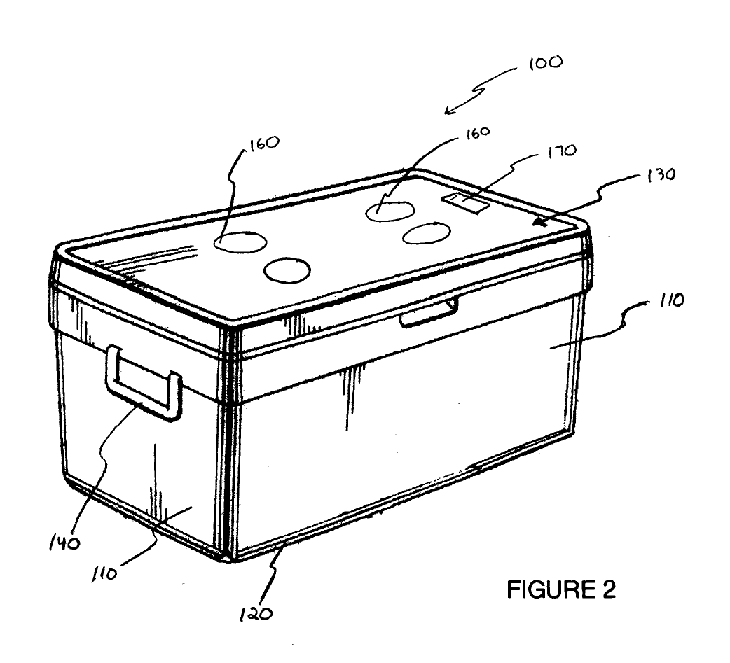

Referring now to the drawings submitted herewith wherein the various elements depicted therein are not necessarily drawn to scale and wherein like elements are identified with like reference numerals throughout the views and figures and in particular FIGS. 1 and 2, there is illustrated a preferred embodiment of a portable storage unit 100.

The portable storage unit 100 comprises of a substantially hollow and rectangular insulated container 105, having an interior volume. The rectangular insulated container 105, has a storage compartment 107, a lid 130, that is hingedly attached to the storage compartment 107 by conventional mechanical methods and is of substantial size to adequately cover insulated container 105. Although the lid 130 illustrated as being hingedly attached to storage compartment 107, it is further contemplated within the scope of the present invention that there are many embodiments for securing the lid to the storage compartment 107 and further embodiments having a lid 130 independent from the storage compartment 107.

The storage compartment 107 is formed by four walls 110 and the bottom 120. The four walls 104 are made of plastic or other suitable material and also contain therein a foam or polyurethane material to provide thermal insulation. The storage compartment 107 functions to thermally isolate the interior volume from its surroundings. It is contemplated within the scope of the present invention that the storage compartment 107 could function to maintain a temperature that is either higher or lower than that of the surrounding environment. The four walls 110 and the bottom 120 are manufactured as a one-piece assembly through conventional injection molding process or other similar mode of manufacturing. It is contemplated within the scope of the present invention that the storage compartment 107 could be formed by numerous different amounts of walls in order to form a storage compartment 107 with a variety of shapes. More specifically but not by way of limitation, the rectangular insulated container 105 could have alternate configurations such as an annular shape.

The lid 130, is generally rectangular in shape and is of sufficient size to substantially cover the opening 135. The lid 130 is manufactured from a suitable durable material such as plastic. The lid 130, also contains therein a suitable insulation material such as foam or polyurethane as is known in the art. The lid 130 is hingedly attached to one of the four walls 111 proximate the opening 135. Although the lid 130 is primarily used to control access to the storage compartment 107 and the contents therein, it is contemplated within the scope of the present invention that other embodiments and functions are possible. More specifically but not by way of limitation, alternate shapes and functions of the lid 130 could be manufactured. Many varieties of shapes manufactured in order to correspond to the shape of the opening 135. It is also contemplated within the scope of this invention that there exist many possible methods of attachment or that no method of attachment exist for the lid 130, to one of the four walls 110.

Still referring to FIG. 1, the handle 140 consists of one piece of plastic or other suitable material that is generally rectangular in shape containing an aperture for a user's hand. The handle 140 is pivotally attached to the externally oriented surface of one of the four walls 110 in close proximity to the lid 140. An additional handle is pivotally attached to the opposing wall 110. The handle 140 is secured to the portable storage unit 100 by way of a suitable mechanical device such as but not limited to a clevis. Although the handle 140 is shown to be generally rectangular in shape with an aperture it is within the scope of the present invention that numerous shapes could be used to produce the same function. Those skilled in the art will also recognize that numerous shapes and materials may be used in place of and/or in conjunction with the handle 140 in order to achieve the function described herein.

Referring in particular FIG. 1, a light 150 is mounted to the internal facing surface of the lid 130 and is generally rectangular in shape. The light 150 is mounted to the lid 130 using a suitable mechanical or chemical method such as but not limited to screws and/or adhesives. The light 150 contains at least one bulb, which is covered by a translucent or transparent surface. It is contemplated within the scope of the present invention that the light 150 could be manufactured from led lights, fluorescent lights or incandescent lighting. The translucent surface serves as protection for the bulb and the light 150 from moisture or impact. The light 150 is electrically coupled with a conventional power source to by a suitable method such as an insulated copper wire. It is contemplated within the scope of the present invention that the conventional power source could be disposed within the lid 130. Furthermore, the conventional power source could be manufactured from lithium or alkaline batteries or a rechargeable battery unit.

It is contemplated to be within the scope of this invention that light 150 could be incorporated into portable storage unit 100 in various ways, including but not limited integrated into lid 130, and connected to or integrated into one or more of the four walls 110. It is further contemplated that more than one light 150 could also be utilized in the single portable storage unit 110 in the manners described herein.

Operably connected to the light 150 is a switch 170. The switch 170 is superposed to the lid 130 opposite the storage compartment 107. The switch 170 is a conventional electric switch that controls the flow of electric current to the light 150. The switch 170 has a first or off position in which no current is allowed to flow to the light 150 from the power source. In its second or on position, the switch closes the circuit between the power source and the light 150 allowing the light to operate. Although in the drawings submitted herewith, the switch 170 is illustrated as being mounted to the lid 130, it is contemplated within the scope of the present invention that the switch 170 could be intermediate the lid 130 and one of the four walls 110 proximate the opening 135 so that when the lid 130 is moved to its open position that the light 150 would be operably engaged with a power source thereby substantially illuminating the storage compartment 107.

Superposed on the lid 130 opposite the opening 135 are a plurality of retaining rings 160. The retaining rings 160 are generally annular in shape and have a sufficient depth in order to releasably secure an item such as but not limited to a beverage can. Although the portable storage unit 100 is illustrated in the drawings submitted herewith with four retaining rings 160, it is contemplated within the scope of the present invention that the portable storage unit 100 could be manufactured with only one retaining ring 160 superposed on the lid 130.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A container for providing thermal isolation, comprising:
a storage compartment having at least one wall and a bottom, said wall and bottom being configured to define an interior volume configured for receiving objects therein, said storage compartment having an opening;
a lid configured to fit into the opening of said storage compartment, said lid for substantially covering the opening of said storage compartment; and
a mechanism operable to illuminate at least a portion of the storage compartment

2. The device as recited in claim 1, and further including a switch, said switch for controlling said mechanism.

3. The device as recited in claim 1, wherein at least a portion of said mechanism is integrated with said lid.

4. The device as recited in claim 1, wherein said mechanism for illuminating includes at least one of led lights, fluorescent lights and incandescent lights.

5. The device as recited in claim 1, and further including a handle attached to said wall for facilitating the lifting and moving of the device.

6. The device as recited in claim 1 and further including at least one retaining ring, said retaining ring superposed on said lid opposite said opening, said retaining ring configured to receive a beverage can.

7. An container for providing thermal isolation, comprising:
a plurality of insulated walls and an insulated bottom, said plurality of insulated walls and insulated bottom being configured to form a storage compartment having an interior volume configured for receiving objects therein, said plurality of insulated walls and insulated bottom further being configured to have an opening;
an insulated lid configured to substantially cover said opening, said lid for closing said opening; and
a light unit disposed on said insulated lid, said light unit operable to illuminate at least a portion of the storage compartment.

8. The device as recited in claim 7 and further including a switch, said switch electrically coupled with said light unit.

9. The device as recited in claim 8, wherein said switch being disposed on said insulated lid.

10. The device as recited in claim 9, wherein said light unit inlcudes at least one of led lights, fluorescent lights and incandescent lights.

11. The device as recited in claim 10, and further including a handle attached to one of said plurality of insulated walls for facilitating the lifting and moving of the device.

12. The device as recited in claim 11 and further including four retaining rings, said retaining rings superposed on said lid opposite said opening, said retaining rings configured to releasably secure a conventional beverage can.

13. A portable cooler having an interior volume configured to maintain a temperature dissimilar to that of its surroundings comprising:
four insulated walls and an insulated bottom, said four insulated walls and insulated bottom being configured to form a storage compartment having an interior volume for receiving objects therein, said four insulated walls and insulated bottom being configured to have an opening;
an insulated lid hingedly attached to one of said four insulated walls, said insulated lid configured to substantially cover and close said opening;
a light unit for illuminating the interior volume of the storage compartment; and
a switch for controlling said light unit, said switch having a first position and a second position.

14. The portable cooler as recited in claim 13, wherein said switch is superposed said lid.

15. The portable cooler as recited in claim 14 and further including four retaining rings, said retaining rings superposed on said lid opposite said opening, said retaining rings configured to receive beverage containers.

16. The portable cooler as recited in claim 15, wherein said light unit is manufactured from a group of lighting materials consisting of led lights, fluorescent lights or incandescent lights.

17. The portable cooler as recited in claim 16, wherein said light unit is mounted on said lid.

18. The portable cooler as recited in claim 17, and further including two handles pivotally secured to opposing walls of said four walls for facilitating the lifting and moving of the portable cooler.

19. The portable cooler as recited in claim 18, wherein said switch in said second position allows electric current to flow to said light unit.

20. The portable cooler as recited in claim 19, wherein said four walls and said lid are manufactured from polyurethane.
